(19) United States
(12) Patent Application Publication
(10) Pub. No.: US 2003/0024421 A1
(43) Pub. Date: Feb. 6, 2003

(54) Method of controlling a light grid

(75) Inventors: Ingolf Braune, Gundelfingen (DE); Roland Bergbach, Emmendingen (DE)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Sick AG, Waldkirch (DE)

(21) Appl. No.: 10/211,477

(22) Filed: Aug. 1, 2002

(30) Foreign Application Priority Data
Aug. 3, 2001 (DE) 10138223.5

(51) Int. Cl. F16P 3/14

(52) U.S. Cl. 100/348; 340/556; 250/221; 340/686.6; 340/680

(57) ABSTRACT

The invention relates to a method of controlling a light grid with a monitored zone for the securing of a hazardous zone pre-determined by a tool movement which is activated with the tool movement. A closed region of the monitored zone is activated as an active field. This active field is moved within the monitored zone such that the hazardous zone is initially only partly secured during the tool movement.

The invention relates to a method of controlling a light grid with a monitored zone to secure a hazardous zone pre-determined by a tool movement, said monitored zone being activated by the tool movement. Such a method serves to protect a worker, who operates the tool or a machine comprising the tool, from injury.

A workpiece to be machined is usually brought into the area of the tool and subsequently the tool movement required for the work process in question is triggered. The hazardous zone pre-determined by the arrangement and direction of movement of the tool is secured by means of a light grid so that the worker, and in particular his hands, are not injured by the tool movement. The light grid forms, for example by a plurality of light barriers extending parallel and adjacent to one another, a usually areal monitored zone which adjoins the hazardous zone or is arranged adjacent thereto. The monitored zone is activated before or by the tool movement. It is therefore monitored whether an intervention into the monitored zone takes place and, accordingly, whether at least one of the transmitted light beams is interrupted. If this is the case, a switching off signal is usually produced which ultimately results in an abortion of the tool movement in order to prevent a possible injury to the worker.

The distance of the worker from the hazardous zone desired for safety reasons also, however, has the result that the worker cannot carry out any adjustment interventions, for example to hold or to guide a workpiece to be machined. This can result in a comparatively low economic efficiency of the work process or-if the worker reaches into the already activated monitored zone-to frequent procedural disruptions.

It is an object of the invention to make possible the securing of a hazardous zone by means of a light grid in a manner in which interventions into the hazardous zone are possible without endangering the safety of the worker.

This object is satisfied for a method of the kind initially named in that a closed region of the monitored zone is activated as an active field and this active field is moved within the monitored zone such that the hazardous zone is initially only partly secured during the tool movement.

The method in accordance with the invention is based an on adaptation to the typical movement procedure of the tool. In many applications, it is the case that a fast closing movement of a first tool part first takes place in the direction of an associated second tool part and only then does a slower machining movement take place with which the actual machining of the workpiece is carried out. In this connection, the invention is based on the recognition that an intervention into the hazardous zone should still be possible during the fast closing movement as long as a sufficiently large opening is present between the two tool parts to still be able to prevent an injury to the worker. With the invention, the hazardous zone is therefore only completely secured, or additionally secured by means of further measures, when the opening between the two tool parts has been reduced to a size which can become an actual hazard for the worker, with a slowing down path of the tool, which will be explained in the following, also being able to be taken into account.

During the fast closing movement of the tool, there is thus a part securing of the hazardous zone to the effect that an intervention into an unsecured part of the hazardous zone still does not result in the production of a switching off signal. On the other hand, however, the part securing of the hazardous zone by the moving active field can protect the worker from injury within particularly dangerous parts of the hazardous zone, for example from an injury by bending edges or cutting edges at one of the tool parts.

With respect to closed gating fields, by which a predictable, and thus programmable, movement of a tool into the hazardous zone should be made possible, the invention is based on an exactly reversed solution approach: with the method in accordance with the invention, a closed region of the monitored zone is namely secured which corresponds to the spatial zone of the instantaneously actually existing danger for the worker.

The invention thus provides the advantage that the workpiece to be machined can still be held and/or adjusted during a part, or during the whole, of the fast closing movement of the tool which ultimately results in an increase in the economic efficiency of the working process without putting the worker at risk.

For this purpose, the monitored zone of the light grid is activated at the latest at the start of the tool movement, or briefly thereafter, and indeed as an active field with a closed, limited, substantially gap-free area. Such a closed region of the monitored zone can, for example, be formed by one or more light barriers extending parallel to one another and adjoining one another.

This active field is moved in a manner which corresponds to the tool movement, as will be explained in the following. The respectively remaining region of the monitored zone is deactivated for such a movement of the active field, that is no monitoring takes place there and, accordingly, no switching off signal can be produced. The active field can be moved in a purely translatory manner in that it is displaced within the monitored zone with a substantially unchanging area. However, the movement of the active field is also to be understood as an enlargement or a reduction in the active area in which at least a boundary of the active field remains unchanged. In other words, the active field is changed for a movement with respect to its position and/or with respect to its extent.

It must further be noted that the hazardous zone named in connection with the invention is to be understood as that spatial region within which, as a result of the movement of the tool, there is potentially, that is at least from a specific stadium of the tool movement, a risk of injury to the worker. The hazardous zone is thus, as a rule, pre-determined by the outline of an access opening of the tool or of the machine in question, on the one hand, and by the possible direction and depth of the tool movement, on the other hand.

With a number of applications of the invention, the hazardous zone moves with the movement of the tool, since the danger for the worker ultimately originates from the tool. With such a movement of the hazardous zone, this can change its position and/or its extent. If, for example, an upper tool moved toward a lower tool arranged in a fixed position, the upper limit of the hazardous zone accordingly moves downwardly while the lower limit of the hazardous zone remains unchanged.

With a preferred embodiment of the method in accordance with the invention, the movement of the active field follows the tool movement or a movement of the hazardous zone during the part securing of the hazardous zone. This corresponds to the function of the securing of particularly dangerous parts of the hazardous zone by the active field.

With an advantageous further development of the invention, the hazardous zone is fully secured by the active field during a further tool movement subsequent to the explained part securing. In other words, from this point in time, any intervention into the hazardous zone or into the remaining part of the hazardous zone results in a switching off signal.

It is possible as an alternative to this for the active field of the monitored zone to continue to partly secure the hazardous zone without any further movement after it has partly secured the hazardous zone and has been moved for this purpose with the movement of the tool or of the hazardous zone. It is also possible for the monitored zone to be completely deactivated at the said point in time, that is for the securing of the hazardous zone to no longer take place by the light grid. In these two cases, instead of this a further optoelectronic sensor can be provided, for example a reflection light scanner or a light barrier, by which the part of the hazardous zone still remaining at this point in time is secured.

Such a procedure can in particular be considered when a workpiece must penetrate the monitored zone, and thereby project into the hazardous zone, due to its dimensions during the whole tool movement, and in particular during the actual machining movement of the tool, without thereby causing a switching off signal. For this purpose, the active field of the monitored zone is moved up to the workpiece into an intermediate position and the securing of the hazardous zone is carried out from this point in time, additionally or exclusively, by means of the said optoelectronic sensor.

With a further advantageous embodiment of the method in accordance with the invention, the movement of the active field during the part securing of the hazardous zone takes place such that the active field leads the movement of the tool, or a movement of the hazardous zone, by a slowing down path-or by an even further path. This slowing down path is to be understood as the braking path of the moving tool or of that tool part from which the danger for the worker originates and which defines the instantaneous boundary of the hazardous zone. This slowing down path can be defined before the actual working process, for example by means of a separate sensor, to be used as the basis for the minimum extent or for the movement profile of the active field within the framework of the method in accordance with the invention.

With the method in accordance with the invention, only a single closed region of the monitored zone is preferably activated as the active field. It is, however, also possible for a plurality of, in particular two, closed regions of the monitored zone to be provided as active fields. This is in particular of advantage when-for example with a robot-two tool parts are provided which are not only moved relative to one another, but are both moved with respect to the workpiece to be machined and thereby form separate hazardous zones.

The method in accordance with the invention is used in a particularly advantageous manner for the securing of a hazardous zone of a bending press or of a stamping tool. In this case, the worker can namely still work -during the part securing of the hazardous zone-directly at the bending line, for example to hold or to adjust the workpiece.

Further embodiments of the invention are laid down in the dependent claims.

The invention will be explained in the following by way of example with reference to the Figures, in which are shown:

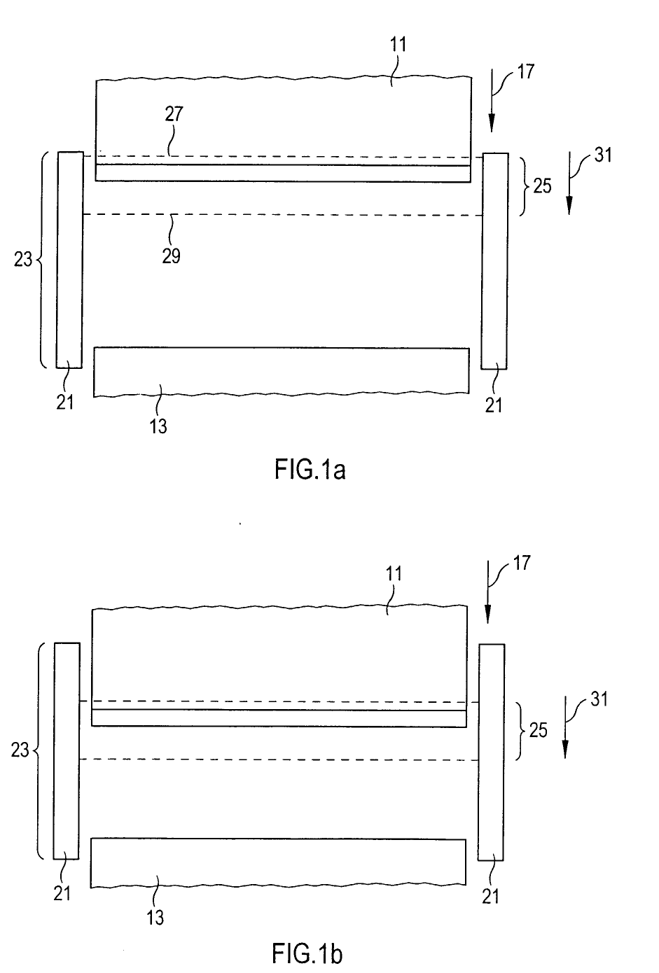

FIGS. 1a and 1b front views of parts of a bending press;

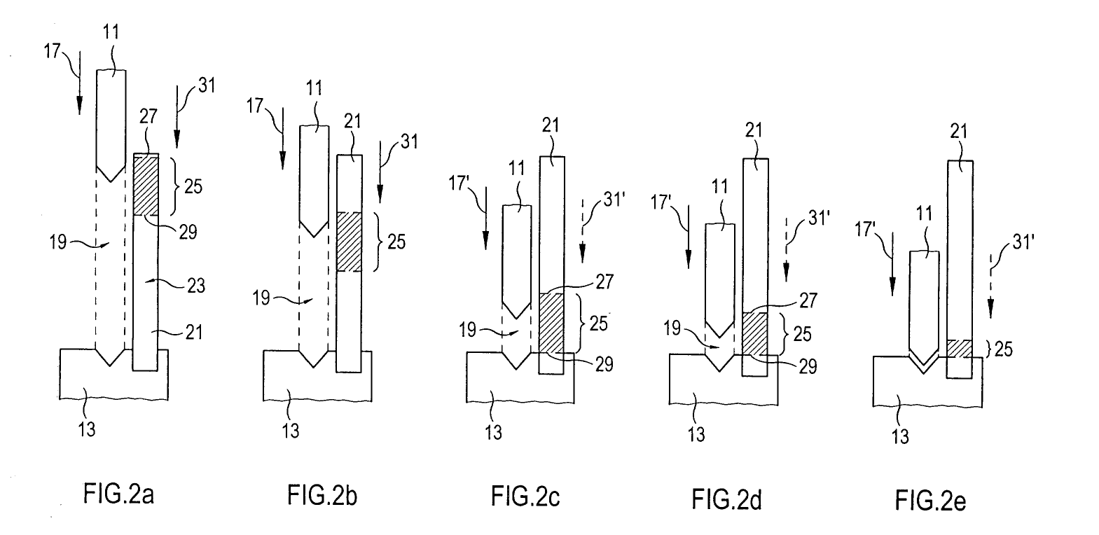

FIGS. 2a to 2e side views of the bending press during the procedure of the method in accordance with the invention;

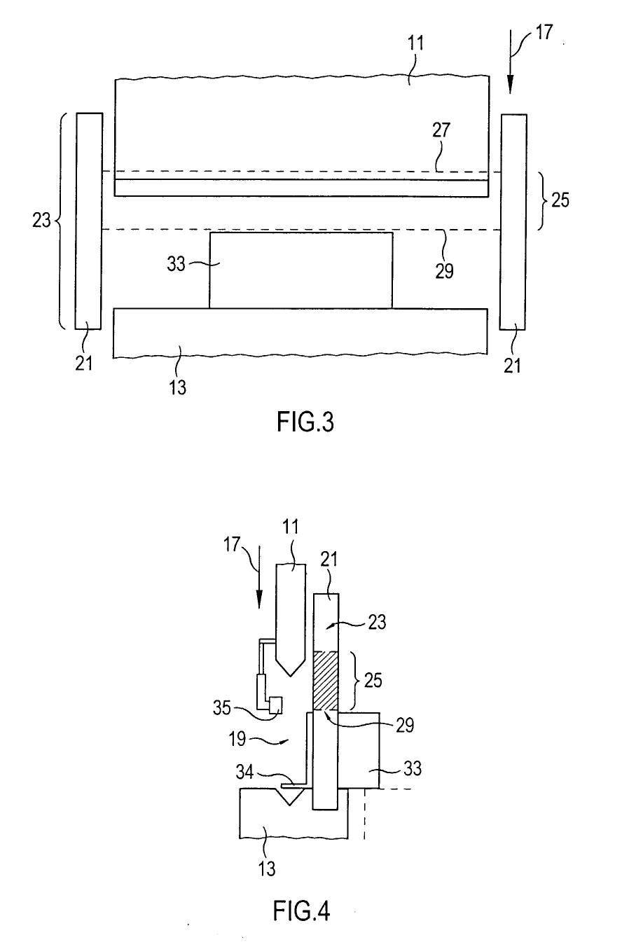

FIG. 3a front view of a bending press with additional securing of the hazardous zone; and

FIG. 4a side view of this bending press.

FIGS. 1a and 1b, and 2a to 2e, show different stages of the method in accordance with the invention which is carried out on a bending press, with the FIGS. 1a and 2a, and the FIGS. 1b and 2b, each corresponding to one another.

The bending press has two tool parts, namely an upper tool 11 and a lower tool 13. The lower tool 13 is disposed on a machine table (not shown). Holding and bending aids (not shown) serve for the putting down of a workpiece. The upper tool 11 can be driven to make a vertically downwardly directed closing movement 17 in order ultimately to bend a workpiece, for example a metal sheet, which has been inserted between the upper tool 11 and the lower tool 13 acting as a counter-tool.

The spatial region, which extends-starting from the upper tool 11-in the direction 17 of the lower tool 13 , forms a hazardous zone 19 for an operator (worker) who inserts the workpiece between the upper tool 11 and the lower tool 13 and adjusts and holds it in a specific position there (cf. FIG. 2a).

Two sensor posts 21 are arranged at both sides of the bending press, and indeed directly in front of the hazardous zone 19. In detail, these comprise light transmitters and light receivers, none of which are shown, to form a plurality of light barriers which extend horizontally and adjacent to one another between the two sensor posts 21. A light grid is hereby formed with a monitored zone 23 which extends between the two sensor posts 21, on the one hand, and along the total height of the sensor posts 21, on the other hand, in the form of a rectangular area.

The monitored zone 23 of the light grid serves for the securing of the hazardous zone 19 against an unauthorized intervention of the worker to prevent injuries, for example to the fingers of the worker, by the upper tool 11 and the lower tool 13 during the closing procedure. For this purpose, a control circuit (not shown) is provided by means of which the monitored zone 23 can be fully or partly activated. This means that transmitted light is transmitted and monitoring for reception is performed for the part of the monitored zone 23 in question in order to produce a switching off signal which results in the interruption of the closing movement 17 of the upper tool 11, when an interruption of the light barrier in question is detected.

As already mentioned, it is possible for only a part of the monitored zone 23 to be activated. To the extent that this activated part of the monitored zone 23 is a closed area, it is termed an active field 25 in the following. Due to the arrangement of the two sensor posts 21, which is particularly simple for the practical realization, confronting one another at the sides, the active field 25 always extends in the form of a rectangular strip from the one sensor post 21 to the other sensor post 21, with a horizontal upper boundary 27 and a horizontal lower boundary 29.

A possible procedure of the method in accordance with the invention will be described in the following:

At the start of the lowering movement 17 of the upper tool 11, which is carried out during a closing movement (FIGS. 1a, 2a; 1b, 2b; 2c) at increased speed, only an upper part of the monitored zone 32 is activated as an active field 25. As can be seen from FIG. 1a, the active field 25 covers the lower part of the upper tool 11, including a bending edge or cutting edge arranged thereon, and it extends beyond this edge even further downwardly. However, there is still sufficient room between the active field 25 and the lower tool 13 to be able to introduce a workpiece into hazardous zone 19 or to be able to align it there (cf. FIG. 2a).

As the downward movement 17 of the upper tool 11 starts, the active field 25 is also moved downwardly-by a corresponding control of the light transmitters and light receivers contained in the sensor posts 21-as is shown by the solid arrow 31 in FIGS. 1a and 2a. This movement 31 of the active field 25 does not only place in the same direction, but also at the same speed as the downward movement 17 of the upper tool 11 so that the active field 25 initially maintains its position relative to the upper tool 11.

This can be seen, for example, from FIGS. 1b and 2b. That part of the hazardous zone 19 is therefore also secured by the active field 25 here which corresponds to the lower part of the upper tool 11 and the spatial area located directly beneath it. The hazardous zone 19 is thus also only partly secured during this stage of the fast closing movement 17 so that an intervention into the hazardous zone 19 is still possible beneath the active field 25, for example to make adjustment measures.

The state shown in FIG. 2c is ultimately reached due to this movement 31 of the active field 25 parallel to the fast closing movement 17 of the upper tool 11: the lower boundary 29 of the active field 25 now directly adjoins the workpiece lying on the lower tool 13, or-if no workpiece is present (as shown)-the workpiece 13 so that an intervention into the remaining hazardous zone 19 is no longer possible without triggering a switching off signal (complete securing of the hazardous zone 19). From this point in time (the so-called switch-over point), the following further procedure takes place with the embodiment shown:

The upper tool 11 is now driven at a reduced speed with respect to the prior closing movement to make a continued downwardly directed machining movement 17′. Moreover, the lower boundary 29 of the active field 25 is now maintained in a fixed position; that is the lower side 19 of the active field 25 continues to precisely adjoin the surface of the workpiece 13 or-if no workpiece is present-the lower tool 13 due to a corresponding control of the light barriers.

However, the active field 25 is continued to be moved to the extent that its upper boundary 27 initially still follows the movement 17′ of the upper tool 11. This movement of the active field 25 is indicated by the broken arrow 31′. The active field 25 thus ultimately changes its size from this point in time.

As can be seen from FIGS. 2d and 2e, the machining movement 17′ of the upper tool 11 and the parallel downward movement 31′ of the upper boundary 27 of the active field 25 are continued. The desired pressing machining or bending machining of the workpiece-not shown-is thereby ultimately achieved, while simultaneously the respectively hazardous zone 19 remains completely secured.

It must still be noted with respect to the embodiment in accordance with FIGS. 1a and 1b that the extent and the arrangement of the active field 25 relative to the lower side of the upper tool 11 takes into account the response time of the light grid and the slowing down path of the upper tool 11. Since the active field 25 clearly projects over the lower side of the upper tool 11 in the direction of movement 17 of the upper tool 11 (cf. FIG. 2a and 2b), it is ensured that, after an intervention into the active field 25 and a switching off signal caused hereby, the time required for the production of the switching off signal and the slowing down time caused by inertia of the upper tool 11 driven at a comparatively high speed do not form any additional hazard for the worker.

The embodiment explained can in particular also be modified within the framework of the invention such that the active field 25 admittedly follows the closing movement 17 of the upper tool 11, but thereby continuously changes, in particular initially enlarges, its vertical extent.

FIGS. 3 and 4 show a further embodiment of the method in accordance with the invention, wherein similar parts are provided with the same reference numerals as in FIGS. 1 and 2.

This embodiment relates to the application that a box-shaped workpiece 33, and indeed a cover section 34 projecting into the hazardous zone 19, is to be machined by the bending press. In this connection, the problem exists of the workpiece 33 having to be able to project into the monitored zone 23 without hereby triggering a switching off signal. Sufficient protection for the worker should nevertheless be ensured by means of the arrangement, which is simple to realize, of the two side sensor posts 31 with horizontally extending light barriers.

For this purpose, in accordance with the invention, initially only one active field 25 is activated and moved downwardly together with the upper tool 11, as already described in connection with FIGS. 1a and 2a and FIGS. 1b and 2b. These movements 17, 31 are carried out until the lower boundary 29 of the active field 25 adjoins the upper side of the workpiece 33. The state shown in FIGS. 3 and 4 is thereby achieved.

An optoelectronic sensor 35, for example a reflection light scanner or a light barrier, is now provided (not shown to scale in FIG. 4) for the further securing of the hazardous zone 19. This sensor 35 monitors the part of the hazardous zone 19 which bounds the lower side of the upper tool 11. This monitoring takes place starting from the rear of the hazardous zone, that is from the side lying opposite the monitored zone 23 or the sensor post 21. A securing of such parts of the hazardous zone 19 is thus made possible by the sensor 35 which-due to the necessary intrusion of the workpiece 33 into the monitored zone 23-cannot be secured by the active field 25 of the light grid set up by the sensor posts 21, as is the case in the embodiment in accordance with FIGS. 1 and 2.

The sensor 35 follows the movement 17 of the upper tool 11 at least in part. For this purpose, it is connected to the upper tool 11. Such a connection can be rigid if the movement of the upper tool 11 is not hindered hereby-for example due to an installation of the sensor 35 which is at the side with respect to the view in accordance with FIG. 3. Alternatively, a displaceable connection, for example in the manner of a telescopic connection, can be provided to allow a further downward movement 17 of the upper tool 11 after the sensor 35 has met the lower tool 13.

The sensor 35 can also alternatively be-fixedly or adjustably-connected to the lower tool 13. In this case, an activation of the sensor 35 is possible in dependence on the closing or machining movement.

Starting from the intermediate position of the active field 25 shown in FIGS. 3 and 4, different possibilities exist for the further control of the active field 25: either the field 25 remains, without any further movement, in the position as shown in FIGS. 3 and 4 during the further movement 17 of the upper tool 11. Or the active field 25, and thus the total monitored zone 23, are fully deactivated at the latest after the lower side of the upper tool 11 has passed the upper side of the workpiece 33. It is also possible for the upper boundary 27 of the active field 25 to follow the downward movement 17 of the upper tool 1 1, similar to how already described in connection with FIGS. 2c, 2d and 2e.

Reference numeral list

| | |
|---|---|
| 11 | upper tool |
| 13 | lower tool |
| 17 | closing movement of the upper tool |
| 17′ | machining movement of the upper tool |
| 19 | hazardous zone |
| 21 | sensor post |
| 23 | monitored zone |
| 25 | active field |
| 27 | upper boundary of the active field |
| 29 | lower boundary of the active field |
| 31 | movement of the active field |
| 31′ | movement of the active field |
| 33 | workpiece |
| 34 | cover section |
| 35 | optoelectronic sensor |

1. A method of controlling a light grid with a monitored zone (23) for securing a hazardous zone (19) pre-determined by a tool movement (17, 17′), characterized in that a closed region of the monitored zone (23) is activated as an active field (25) and this active field (25) is moved within the monitored zone (23) such that the hazardous zone (19) is initially only partly secured during the tool movement (17).

2. A method in accordance with claim 1, characterized in that the movement (31, 31′) of the active field (25) follows the tool movement (17, 17′) and/or a movement of the hazardous zone (19) for the part securing of the hazardous zone (19).

3. A method in accordance with claim 1, characterized in that the hazardous zone (19) moves with the movement (17, 17′) of the tool (11).

4. A method in accordance with claim 1, characterized in that an intervention into an unsecured part of the hazardous zone (19) during the part securing of the hazardous zone (19) still does not result in the production of a switching off signal.

5. A method in accordance with claim 1, characterized in that the active field (25) is moved within the monitored zone (23) such that, after the part securing, the hazardous zone (19) is fully secured during a further tool movement (17′).

6. A method in accordance with claim 5, characterized in that, during the full securing of the hazardous zone (19), the movement (31′) of the active field (25) follows the tool movement (17′) and/or a movement of the hazardous zone (19), wherein the active field (25) in particular reduces its extent (27) in dependence on the tool movement (17′) and/or the movement of the hazardous zone (19).

7. A method in accordance with claim 1, characterized in that, after the active field (25) has been moved into an intermediate position for the part securing of the hazardous zone (19), the hazardous zone remains partly secured by the active field, or the monitored zone is completely deactivated, and in that the hazardous zone is monitored by an optoelectronic sensor (35), in particular by a reflection light scanner or a light barrier, for a further securing of the hazardous zone (19).

8. A method in accordance with claim 7, characterized in that, for the additional securing by the optoelectronic sensor (35),
a part of the hazardous zone (19) is secured which is not secured by the active field (25) in the intermediate position; and/or
the hazardous zone (19) is secured from a side lying opposite the monitored zone (23) of the light grid; and/or
the hazardous zone (19) is monitored in the region of the moving tool (11); and/or
the hazardous zone (19) is monitored in the region of a stationary counter-tool (13).

9. A method in accordance with claim 7, characterized in that the optoelectronic sensor (35) follows the total tool movement (17) or part of the tool movement, in particular in that the sensor (35) is rigidly or movably connected to the tool (11).

10. A method in accordance with claim 7, characterized in that the intermediate position of the active field (25) is selected such that a workpiece (33) or a tool of pre-determined dimensions can be inserted into a part of the hazardous zone (19) which is not secured by the active field (25) in the intermediate position, without hereby triggering a switching off signal.

11. A method in accordance with claim 1, characterized in that, during the part securing of the hazardous zone (19), the movement (3 1) of the active field (25) leads the tool movement (17) and/or a movement of the hazardous zone (19) at least by a slowing down path.

12. A method in accordance with claim 1, characterized in that the monitored zone (23) of the light grid has an upper boundary, a lower boundary and two side boundaries, and in particular has the form of a rectangular area, wherein
the active field (25) takes up a rectangular, closed region of the monitored zone (23); and/or
the active field (25) extends from the one side boundary to the other side boundary, or from the upper boundary to the lower boundary; and/or
the active field (25), starting from a boundary, in particular the upper boundary, moves to the oppositely disposed boundary, in particular the lower boundary.

13. A method in accordance with claim 1, characterized in that, for a movement (31, 31′) of the active field (25), one (27) or more (27, 29), in particular two opposite boundaries of the active field, or all boundaries of the active field are modified within the monitored zone (23) of the light grid.

14. A method in accordance with claim 1, characterized in that, during the part securing of the hazardous zone (19), the active field (25) is moved (31) in a purely translatory manner while maintaining its extent.

15. A method in accordance with claim 1, characterized in that, for the part securing of the hazardous zone (19), an upper boundary (27) of the active field (25) follows a downward movement (17, 17′) of an upper boundary of the hazardous zone (19), wherein the upper boundary of the hazardous zone is in particular pre-determined by the lower side of an upper tool (11).

16. A method in accordance with claim 1, characterized in that, during the part securing of the hazardous zone (19), an increasing portion of the hazardous zone is secured and the unsecured part of the hazardous zone is continuously reduced.

17. A method in accordance with claim 1, characterized in that only a single closed region of the monitored zone (23) is activated as an active field (25); or
in that a plurality of closed regions of the monitored zone, in particular two closed regions of the monitored zone, are activated as active fields.

18. A method in accordance with claim 1, characterized in that the method is used for the securing of a hazardous zone (19) of a bending press and/or of a stamping press
